(19) United States
(12) Patent Application Publication
(10) Pub. No.: US 2025/0246802 A1
(43) Pub. Date: Jul. 31, 2025

(54) RADIO FREQUENCY (RF) ANTENNAS FOR COMMUNICATION THROUGH WATER, SEA ICE, OR BOTH

(71) Applicant: University of Washington, Seattle, WA (US)

(72) Inventors: John Mower, Seattle, WA (US); Yasuo Kuga, Seattle, WA (US); Yannan Liu, Seattle, WA (US); Seyyedmohammadhossein Naghavi, Seattle, WA (US)

(21) Appl. No.: 19/041,448

(22) Filed: Jan. 30, 2025

Related U.S. Application Data
(60) Provisional application No. 63/627,582, filed on Jan. 31, 2024.

(51) Int. Cl. H01Q 1/34; H01Q 1/28; H01Q 13/00; H01Q 15/24; H04B 13/02

(52) U.S. Cl. CPC H01Q 1/34; H01Q 1/288; H01Q 13/00; H01Q 15/24; H04B 13/02

(57) ABSTRACT

In one aspect, an antenna may include a waveguide with a dielectric material disposed within the waveguide, where the dielectric material may include a dielectric constant matched or near-matched to a dielectric constant of liquid water. The antenna can selectively be configured to communicate using one or more very high frequency (VHF) or one or more ultra high frequency (UHF) radio frequencies through liquid water.

### CROSS-REFERENCE TO RELATED APPLICATIONS

This application claims the benefit under 35 U.S.C. § 119 (c) of the earlier filing date of U.S. Provisional Application No. 63/627,582 filed Jan. 31, 2024, the entire contents of which are hereby incorporated by reference in their entirety for any purpose.

### BACKGROUND

Some systems use acoustic waves to communicate in and/or through media, such as seawater, sea ice, and/or air. For instance, a first device, for example, an under-water identification (UWID) tag, may be placed on the bottom surface of floating sea ice; and a second device, for example, a lamb wave detector georeferencing identification satellite (LDGRIDSAT) tag, may be placed on the top surface of sea ice. The UWID tag can send acoustic waves to the LDGRIDSAT tag. The LDGRIDSAT tag can then send a communication signal(s) to a satellite(s) of, for example, the Iridium Satellite System.

Some systems use magnetic fields to communicate through sea ice that may be floating on seawater. For example, autonomous underwater vehicles (AUVs) can operate under water and transmit a magnetic field, such as a vertical magnetic field.

Some systems, such as a subglacial wireless transmission system, may use radio frequency (RF) signal(s) in the high frequency (HF) and/or ultra high frequency (UHF) range(s) to measure various properties in deep sea ice. In such systems, a person(s) may drill a deep hole in the sea ice, and the person(s) can place a transmitter inside the hole. The transmitter can then communicate with a receiver on the surface of the sea ice.

Some systems may use optical wireless communication. For example, sea ice diffusion optical communications (SDOCs) can establish high-speed and/or short-distance broadcast communication links between two or more underwater vehicles. In these systems, optical signals can be transmitted and/or received between the underwater vehicles using multiple optical reflections and/or scatterings from the sea ice.

Some systems may be connected to an AUV using an optical fiber tether. The AUV can be inserted under seawater though a drilled hole through the sea ice. The optical fiber tether can be used for deploying the AUV underwater and/or recovering the AUV from water. The optical fiber tether can also be used for communicating with the AUV in real time or near-real time.

### BRIEF DESCRIPTION OF THE DRAWINGS

FIG. 1 shows an environment of an autonomous underwater vehicle under sea ice, where the autonomous underwater vehicle communicates with a satellite through the sea ice, in accordance with examples described herein.

FIG. 2 shows a schematic of a waveguide of an antenna, in accordance with examples described herein.

FIG. 3 shows a schematic of a waveguide of an antenna, where the waveguide includes a matching material surrounding at least an open end of the waveguide, in accordance with examples described herein.

FIG. 4 shows an antenna with a waveguide, a matching material surrounding at least an open end of the waveguide, and a ring in the intercept of the waveguide and the matching material, in accordance with examples described herein.

FIG. 5 shows an antenna with a waveguide, a matching material surrounding at least an open end of the waveguide, and a guide tube surrounding at least a portion of the matching material, in accordance with examples described herein.

FIG. 6 shows an antenna with a waveguide, a matching material surrounding at least an open end of the waveguide, and a guide tube surrounding at least a portion of the matching material, where the guide tube includes an inner layer and an outer layer, in accordance with examples described herein.

FIG. 7 shows a system with a transmitter and a receiver, where the transmitter is communicatively coupled with the receiver, in accordance with examples described herein.

FIG. 8 shows a block diagram of a method to transmit radio frequencies using a guide tube, where the guide tube contacts sea ice, in accordance with examples described herein.

FIG. 9A shows the first year of sea ice attenuation as a function of frequency, in accordance with examples described herein.

FIG. 9B shows a multi-year of sea ice attenuation as a function of frequency, in accordance with examples described.

### DETAILED DESCRIPTION

Remote sensing and/or communication with underwater vehicles, e.g., AUVs, in bodies of water covered by ice (e.g., the Artic Ocean) may be useful in oceanography, military (e.g., navy), commerce (e.g., shipping), and/or other endeavors. Unfortunately, current communication systems, such as one or more satellites, may struggle to sense and/or communicate with AUVs, when the body of water (e.g., seawater) is covered by ice (e.g., ice water). Examples described herein include an RF antenna (“antenna”) that can be used by an AUV or other communication systems to communicate through a medium, such as a liquid solution, seawater, lake water, river water, pure water, frozen, sea ice, lake ice (e.g., frozen or partially frozen lake), air, and/or other media. Although examples described herein may advantageously address issues relating to sensing and/or communicating with an AUV that is located under sea ice, examples of antennas disclosed herein may be utilized to communicate through various media. In some embodiments, example antennas may be used in the dairy, petroleum, chemical, pharmaceutical, food and beverage, cosmetics, or other industries, where the liquid solution and/or medium where the antenna resides may be different.

Generally, sea ice (or frozen water) is a highly dissipative material at ranges of microwave frequencies (or microwave RFs). However, the electromagnetic (EM) signal penetration depth through sea ice increases when the frequency (or RF) of the signal decreases. The increase may be particularly significant when the frequency is lower than, for example, approximately 400 megahertz (MHz). Therefore, when using lower frequencies, the penetration depth of the EM waves and/or RF signals through a medium increases.

Typically, the size of the antenna is positively related to the wavelength of the transmitted signal, or the antenna size is inversely related to the operating frequency. The antenna size, however, can be reduced in examples described herein by using materials with a high dielectric constant to construct the antenna.

In some embodiments, the antenna can include a circular waveguide filled with a material with a high dielectric constant. To transmit an EM wave and/or an RF signal through the sea ice efficiently, the antenna may utilize an impedance matching layer and a flexible guiding structure with silicon oil.

In some embodiments, the antenna(s) described herein: (i) can transmit a circularly polarized EM wave(s) and/or RF signal(s); (ii) has a relatively small size due in part to the high dielectric core of the antenna; (iii) has a relatively wide bandwidth (e.g., approximately 6%, 8%, 10%, 12%, 14%, 16%, 18%, 20%, 22% etc. with respect to the center and/or operating frequency); (iv) has a directional radiation pattern; (v) can withstand high pressure, such that the antenna can be used deep underwater; (vi) can be designed and/or selectively configured to operate in different frequencies; and/or (vii) can be utilized to communicate EM wave and/or RF signals through one or more media.

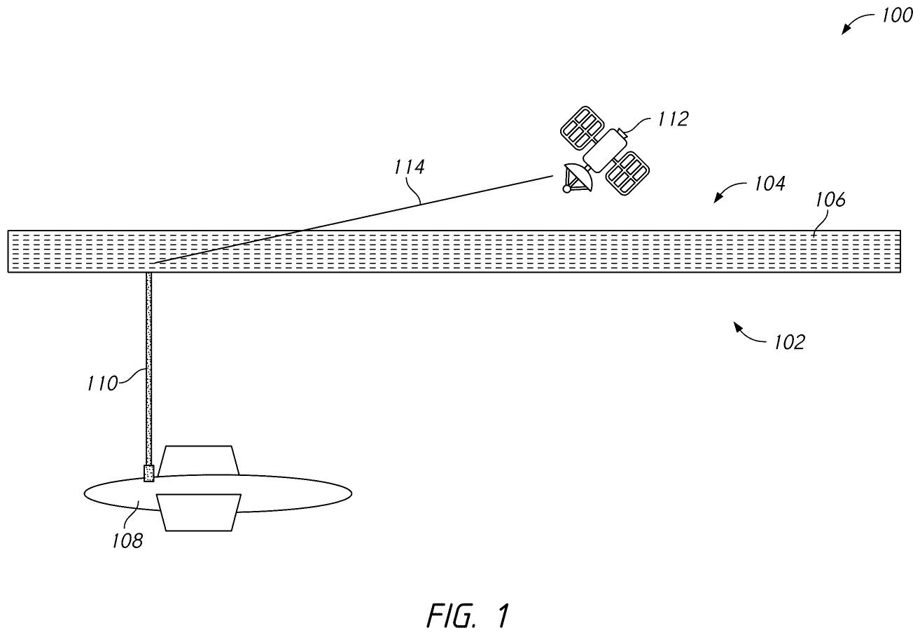

FIG. 1 shows an environment 100 of an underwater vehicle under sea ice, where the underwater vehicle may communicate with a satellite through the sea ice, in accordance with examples described herein. For example, the environment 100 of FIG. 1 includes seawater 102, air 104, sea ice 106, an AUV 108, an antenna 110, a wireless communication 114, and a satellite 112. In some embodiments, the environment 100 may include fewer, additional, and/or different components than what is shown in FIG. 1.

In some embodiments, the AUV 108 may use the antenna 110 to communicate with the satellite 112, another AUV, a laboratory or other structure located on top of the sea ice 106, and/or another receiving device and/or receiving entity. These communications can be performed using the wireless communication 114 and/or another communication coupling. These communications can be accomplished through various media, such as seawater 102, sea ice 106, air 104, and/or other media. While an AUV is described with reference to FIG. 1, other underwater vehicles may utilize antenna and communication technology described herein.

In some embodiments, each transmitting and/or receiving device and/or entity may include a communication interface(s), where the communication interface(s) may support a wireless communication coupling (e.g., a link, the wireless communication 114 of FIG. 1) using a variety of communication protocols and/or standards. Examples of such protocols and standards include: a 3rd Generation Partnership Project (3GPP) Long-Term Evolution (LTE) standard, such as a 4th Generation (4G) or a 5th Generation (5G) cellular standard; an Institute of Electrical and Electronics (IEEE) 602.11 standard, such as IEEE 602.11g, ac, ax, ad, aj, or ay (e.g., Wi-Fi 6® or WiGig®); an IEEE 602.16 standard (e.g., WiMAX®); a Bluetooth Classic® standard; a Bluetooth Low Energy® or BLE® standard; an IEEE 602.15.4 standard (e.g., Thread® or ZigBee®); various protocols used to communicate with one or more satellites (e.g., the satellite 112 of FIG. 1); and/or other protocols and/or standards that may be established and/or maintained by various governmental, industry, and/or academia consortiums, organizations, and/or agencies; and/or so forth.

In some embodiments, the wireless communication 114 between the AUV 108 and the satellite 112 may involve several protocols and/or technologies to ensure reliable data transfer over long distances with minimal or lower interference. For example, the wireless communication 114 may include communication protocols and/or methods, such as: telemetry, tracking, and command (TT&C), which may involve the transmission of monitoring data (telemetry) and/or the sending of commands to the satellite 112; consultative committee for space data systems (CCSDS), which may be and/or include a set of standardized protocols for space data communications, including protocols for telemetry and/or telecommand; frequency division multiple access (FDMA) and/or time division multiple access (TDMA), which may include multiplexing techniques used to allocate communication bandwidth among multiple users or systems; carrier frequency, such as the satellite 112 may use specific frequency bands for communication, for example, an L-band, an S-band, a C-band, a Ku-band, a Ka-band, etc.; various modulation schemes, such as phase shift keying (PSK), quadrature amplitude modulation (QAM), etc.; various error correction protocols, such as forward error correction (FEC), etc.; an Internet Protocol (IP), if the satellite 112 provides an Internet service; or a combination thereof. Generally, the protocol and/or the method of the wireless communication 114 is chosen based on the AUV 108's and/or the satellite 112's mission requirements, their respective operational environment, and/or their respective technological constraints.

In some embodiments, the AUV 108 (or, for example, generally, an underwater vehicle) may use the antenna 110 to communicate with the satellite 112, another AUV (not illustrated in FIG. 1), a laboratory or another structure located on top of the sea ice 106, a device (e.g., an instrumentation device) embedded in the sea ice 106, and/or another receiving device and/or receiving entity via, for example, a network.

In some embodiments, the antenna 110 may include a waveguide with a dielectric material disposed within the waveguide. The dielectric material may have a dielectric constant matched or near-matched to a dielectric constant of a liquid solution, seawater, lake water, river water, pure water, a liquid water (e.g., having impurities), the seawater 102, and/or other types of liquid solutions and/or media. These types of liquid solutions and/or media may have different dielectric constants due to different levels of salinity (e.g., from zero to fully saturated), different levels of mineral(s), different levels of biological material(s), and/or different impurities. To that end, the dielectric constant of the dielectric material of the waveguide of the antenna 110 may be at times near-matched (e.g., instead of exactly matched) to the dielectric constant of the liquid solution and/or medium where the antenna resides. For example, the dielectric constant of the dielectric material of the waveguide of the antenna 110 may be up to 1 percent (%), 3%, 5%, 7%, 10%, or 20% different from the dielectric constant of the seawater 102 in various examples, where the antenna 110 is shown in FIG. 1 as residing or transmitting through. As another example, the antenna 110 may reside in a lake (e.g., instead of the seawater 102), yet the antenna 110 may still be used to successfully communicate EM waves and/or RF signals. As yet another example, the real part of the permittivity (e.g., the dielectric constant) for seawater 102 and lake water may be approximately the same. The imaginary part of the permittivity may vary more with salinity. Therefore, this variance of the imaginary part of the permittivity of water may have little to no effect on the antenna 110 features and/or characteristics to effectively communicate EM waves and/RF signals.

Note that the waveguide and the dielectric material disposed within the waveguide may be collectively referred herein as a loaded waveguide. The antenna 110 may selectively be configured to communicate using one or more very high frequency (VHF) or ultra high frequency (UHF) radio frequencies through the liquid water or the seawater 102. For example, when the AUV 108 communicates with another AUV (not illustrated in FIG. 1), the dielectric material disposed within the waveguide of the antenna 110 may improve the wireless underwater communication between the two AUVs, while keeping the design of the antenna 110 relatively small compared to an antenna with a waveguide that is filled with air or gas (e.g., an unloaded waveguide).

In some embodiments, the antenna 110 may also include another material surrounding an end of the waveguide of the antenna 110, for example, at the end closer to the sea ice 106. In some embodiments, this other material may have a dielectric constant matched or near-matched to a dielectric constant of ice, frozen water, or the sea ice 106. For example, the AUV 108 may use the antenna 110 to communicate from the seawater 102, through the sea ice 106, and through air 104 with the satellite 112. The bottom of the sea ice 106, however, may have a rough surface. The rough surface may damage the antenna. To that end, the antenna 110 may include or utilize a guide tube surrounding at least a portion of the matching material. The waveguide and the matching material of the antenna 110 are disposed in the guide tube of the antenna 110. The guide tube is configured to contact ice, frozen water, or the sea ice 106 through which the antenna 110 will broadcast RF signals to communicate with, for example, the satellite 112, a laboratory or another structure located on top of the sea ice 106 (not illustrated in FIG. 1), and/or a device (e.g., an instrumentation device) embedded in the sea ice 106 (not illustrated in FIG. 1).

In some embodiments, the network may be a cellular network, the Internet, a wide area network (WAN), a local area network (LAN), a wireless LAN (WLAN), a wireless personal-area-network (WPAN), a mesh network, a wireless wide area network (WWAN), a peer-to-peer (P2P) network, and/or Global Navigation Satellite System (GNSS).

In some embodiments, the GNSS may be, include, and/or utilize state-, internationally-, corporate-, and/or privately-funded and/or managed systems, such as the Global Positioning System (GPS), Galileo, the Quasi-Zenith Satellite System (QZSS), the BeiDou, the GLObal NAvigation Satellite System (GLONASS), the Indian Regional Navigation Satellite System (IRNSS), Argos, Iridium, Starlink, and/or other GNSSs, satellites, and/or satellite constellations.

In some embodiments, the communication frequency, the operating frequency, the bandwidth, and/or the data rate of the wireless communication 114 may depend on the communication frequency, the operating frequency, the bandwidth, the directionality of the wireless communication 114, and/or the data rate supported by the satellite 112.

For example, if the satellite 112 is part of Argos, the communication frequency and/or the operating frequency of the wireless communication 114 may be approximately 400 MHZ; the communication coupling 114 may support circular polarization; the wireless communication 114 may have a bandwidth of, at least, or approximately 1.77 MHz; and/or the wireless communication 114 may have and/or support a data rate of, at least, or approximately 400 bits per second (bps).

As another example, if the satellite 112 is part of the GPS, the communication frequency and/or the operating frequency of the wireless communication 114 may be approximately at least 1575 MHz; the communication coupling 114 may support right-hand circular polarization; and/or the wireless communication 114 may have a bandwidth of, at least, or approximately 24 MHz.

As another example, if the satellite 112 may be part of Iridium, the communication frequency and/or the operating frequency of the wireless communication 114 may be approximately 1610-1626.5 MHz; the communication coupling 114 may support right-hand circular polarization; and/or the wireless communication 114 may have a bandwidth of, at least, or approximately 16.5 MHZ.

As yet another example, if the satellite 112 is part of Starlink, the communication frequency and/or the operating frequency of the wireless communication 114 may be approximately 1610-1617.8 MHz in a first direction (e.g., Earth to space, sea ice 106 to space); and may be approximately 2483.5-2500 MHz in a second direction (e.g., space to Earth, space to sea ice 106).

FIG. 1 shows the AUV 108 using the antenna 110 to communicate with the satellite 112 of a GNSS. In some embodiments, the antenna 110 is physically coupled between the AUV 108 and the bottom surface or layer of the sea ice 106. The AUV 108 can then communicate with the satellite 112 using the wireless communication 114. In addition to, or alternatively of, the communications illustrated in FIG. 1, the AUV 108, the satellite 112, or another entity (e.g., a laboratory on top of the sea ice 106, another satellite, another AUV, etc.) may facilitate other unidirectional, bidirectional, wired, wireless, direct, and/or indirect communications utilizing one or more communication protocols and/or standards. Note that FIG. 1 does not necessarily illustrate all communication signals or communication couplings that may be used in various examples.

In some embodiments, for underwater communication, the AUV 108 can communicate with another AUV and/or another entity underwater (not illustrated as such in FIG. 1) using the antenna 110, where the antenna 110 is configured to selectively communicate using one or more very high frequency (VHF) and/or one or more ultra high frequency (UHF) radio frequencies through liquid water. Configuring the antenna 110 to select a specific radio frequency of one or more VHF and/or one or more UHF radio frequencies to communicate underwater (e.g., in the seawater 102) may depend on the distance between the AUVs and/or the other entity. Generally, lower frequencies are more suitable for longer distances of communication in an underwater environment because liquid water (e.g., seawater 102) has a considerable signal absorption.

The antenna 110 may be used in various environments, uses, and/or applications. In some embodiments, the antenna 110 may be used to create a through sea ice 106 communication link to establish the wireless communication 114 between the AUV 108 and the satellite 112, as is shown in FIG. 1.

In some embodiments, underwater communication links, EM waves, and/or RF signals may have advantages over the other types of communication, such as optical communication, sonic communication, etc. Examples of the communication links, EM waves, and/or RF signals described herein can support high data transfer rates; can penetrate obstacles between, for example, devices, or through various media (e.g., sea ice 106); may support line-of-sight (LOS) communication and/or non-line-of-sight (NLOS) communication; and/or may have other advantages compared to other types of communication.

In some embodiments, the antenna 110 can be used for tomographic imaging of, for example, the sea ice 106. A communication system can use one or more antennae 110 (or antennas 110) for tomographic imaging of a thick ice layer (e.g., sea ice 106), for example, in Greenland, Antarctica, or another environment with a permanent or a semi-permanent ice layer. One or more antennae 110, operating in relative low frequencies (e.g., 100 MHz, 200 MHZ, 300 MHz, 700 MHz, or another low operating RF), can be placed at the bottom of the sea ice 106. In such a case, transmitted RF signals can be measured on the surface of the sea ice 106 at different spatial locations. Scientists can then use reconstruction methods to create a 3D image of the internal structures of the sea ice 106, where the internal structure of the sea ice 106 may include liquid water, air gaps, minerals, rocks, biological materials, etc. For such uses, the antenna 110 may have an end-fire radiation pattern. The end-fire radiation pattern of the antenna 110 may refer to a directional pattern, where the main lobe of the radiation is focused along the axis of the antenna 110, for example, in the direction of the antenna 110's length. This means that the maximum radiation or reception of the antenna 110 may occur at the ends of the antenna 110, as opposed to the broadside pattern, where the radiation may be perpendicular to the axis.

In some embodiments, the antenna 110 may be used for microwave sensing in harsh environments. Additionally, or alternatively, the antenna 110 can be used as a sensor in these harsh environments. Harsh environments may include a tundra, storms, hurricanes, wildfires (e.g., smoke, ash), volcanic ash, deserts (e.g., sandstorms), etc.

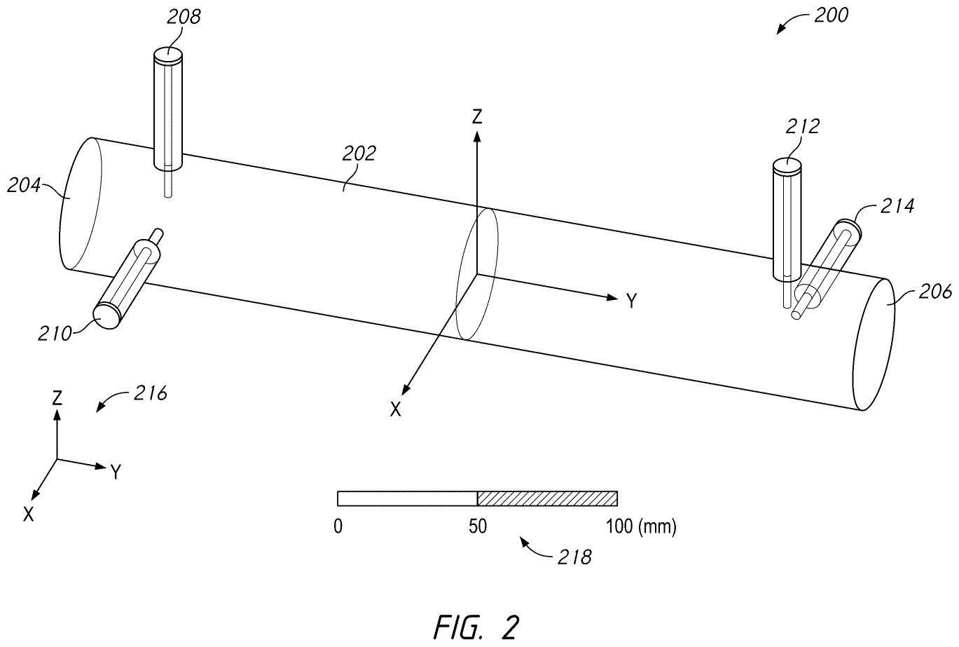

FIG. 2 shows a schematic of a waveguide 202 of an antenna 200, in accordance with examples described herein. FIG. 2 is illustrated and/or described in the context of FIG. 1. For example, the antenna 110 of FIG. 1 may include and/or utilize the waveguide 202 of FIG. 2.

The antenna 200 of FIG. 2 shows a waveguide 202, an end 204 of the waveguide 202, an end 206 of the waveguide 202, a probe 208, a probe 210, a probe 212, a probe 214, a 3D axes 216, and a scale 218. In some embodiments, the end 204 of the waveguide 202 may be a first closed end, and the end 206 of the waveguide 202 may be a second open end. In some embodiments, the end 204 of the waveguide 202 may be first open end, and the end 206 of the waveguide 202 may be a second closed end. The size and/or shape of the waveguide 202 is an example size and/or shape of a waveguide that can be utilized for RF communication. The waveguide 202 of FIG. 2 has a cylindrical shape. Alternatively, the waveguide of the antenna can have another shape, such as a cuboid, a triangular prism, a pentagonal prism, an hexagonal prism, an octagonal prism, another prism, or another 3D shape.

In some embodiments, using an antenna (e.g., antenna 110 of FIG. 1, antenna 200 of FIG. 2) with a cylindrical waveguide (e.g., waveguide 202 of FIG. 2) may include several advantages over waveguides with other geometric shapes. These advantages may include mode selectivity, where the cylindrical waveguide 202 can suppress higher-order modes better than non-cylindrical shapes, which may simplify mode management; a symmetrical or quasi-symmetrical radiation pattern, where the cylindrical symmetry of the waveguide 202 may result in a more uniform and/or omnidirectional radiation pattern, which can provide a more consistent signal coverage; lower loss, where the cylindrical waveguide 202 may exhibit lower dielectric and/or conductor losses, which can enhance the efficiency of RF communication using the antenna (e.g., antenna 110 of FIG. 1); case of manufacturing; lower manufacturing cost; an increased structural strength, which can aid with the deployment of the antenna (e.g., antenna 110 of FIG. 1, antenna 200 of FIG. 2) and/or the waveguide (e.g., waveguide 202 of FIG. 2) deep underwater; a combination thereof; or another advantage.

The design (e.g., shape, size, composition, properties) of the waveguide 202 of FIG. 2, the antenna 200 of FIG. 2, and/or the antenna 110 of FIG. 1 may depend on the environment (e.g., the environment 100 of FIG. 1, or another environment), where the antenna may be used and/or deployed; the time period (e.g., one day, one month, one year, multiple years) of the usage of the antenna; or other factors. As such, the scale 218 is an example scale of the design of the waveguide.

In some embodiments, the waveguide 202 may be designed by considering Equation 1, where f_{c} may denote a cutoff frequency; ρₙₘ may denote a mode-dependent constant; μ may denote the permeability; and ε may denote the permittivity.

$${f}_{c} = \frac{{ρ}_{nm}}{2 π \sqrt{μ ε}} \qquad ( Equation 1 )$$

After optimization, the radius of the waveguide 202 (e.g., a loaded waveguide) may be approximately 24 millimeters (mm); feed location may be approximately 33 mm from the end 204 and/or the end 206 of the waveguide 202; and/or the insertion depth may be approximately 14 mm.

In other example loaded waveguides, other lengths, radii, feed locations, and/or insertion depths may be used. Generally, the lengths of the loaded waveguides used herein may be less than 30 centimeters (cm) in length; and the radii of the loaded waveguides may be less than 5 cm. Note that these loaded waveguides may generally be smaller, and therefore more practical for use in underwater communications, than unloaded waveguides. Unloaded waveguides communicating at the same frequency and/or at the same communication distances may generally need to be ten or more times greater in size in length (e.g., two, three, four, five, and so for the meters), and/or have much greater radii. Therefore, unloaded waveguides may be impractical in various applications, uses, and/or environments.

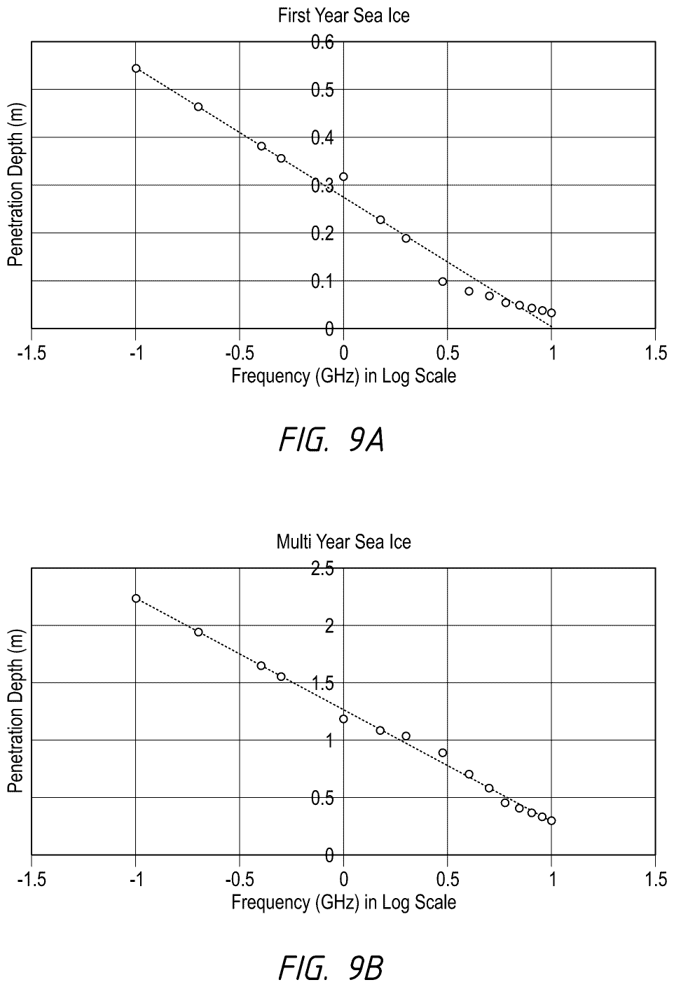

FIG. 9A and FIG. 9B show attenuation as a function of frequency in first year sea ice and multi-year sea ice, respectively, (e.g., sea ice 106 of FIG. 1). The data in FIG. 9A and FIG. 9B may be taken into consideration when designing the antenna 110 of FIG. 1, the waveguide 202, and/or the antenna 200 of FIG. 2, such that the AUV 108 of FIG. 1 can effectively and/or efficiently communicate through sea ice (e.g., the sea ice 106 of FIG. 1).

Generally, pure ice has a dielectric constant (or a relative permittivity), εᵣ, of approximately 3.15; pure water has a dielectric constant, εᵣ, of approximately 80; and seawater 102 has a dielectric constant, εᵣ, of, for example, approximately 70, depending on the salinity of the seawater 102 of FIG. 1.

In some embodiments, the waveguide 202 of FIG. 2 may be a loaded waveguide 202, where the waveguide 202 includes a core that is suitable for the environment (e.g., environment 100 of FIG. 1). The loaded waveguide (e.g., the waveguide 202 of FIG. 2) may be advantageous to reduce the size of the waveguide 202 of FIG. 2 and/or the antenna 110 of FIG. 1 compared to an otherwise unloaded waveguide to communicate the one or more RF signals in a specific environment. Note that examples of unloaded waveguides, generally, may include waveguides that may be filled with air or gas. Although unloaded waveguides can be used to communicate RF signals, these waveguides may be too large in size to be suited for certain applications and/or environments. The loaded waveguide 202 of FIG. 2, however, may be considerably smaller (e.g., shorter and/or narrower) than a waveguide filled with air or gas transmitting at a same frequency.

In some embodiments, if the antenna 110 of FIG. 1 and/or the waveguide 202 of FIG. 2 is used in the environment 100 of FIG. 1, the core or the dielectric material of the loaded waveguide 202 has or includes a dielectric constant that may be matched or near-matched to a dielectric constant of liquid water or seawater 102 of FIG. 1. In some embodiments, the core or the dielectric material of the waveguide 202 may be or include seawater or liquid water. This example design may be prudent and/or advantageous from a cost perspective because water or seawater is an abundant resource.

Additionally, or alternatively, the waveguide 202 may be loaded using seawater, pure water, glycol, or a combination thereof. Glycol can prevent the seawater and/or the pure water inside the loaded waveguide 202 from freezing. The seawater and/or the glycol can also change the characteristics of the RF signals compared to, for example, if the waveguide was to be filled with gas and/or air, since there may be less reflections back due to the change in the media not as dramatic compared to an unloaded waveguide being underwater.

Continuing with the example environment 100 of FIG. 1, in some embodiments, the core or the dielectric material of the loaded waveguide 202 of the antenna 110 of FIG. 1 may be or may include titanium dioxide or titania (TiO₂). Titania has a dielectric constant (or a relative permittivity), εᵣ, of approximately 85 to 96, depending in part on the frequency used to measure the dielectric constant. In that regard, the dielectric constant of titania (or the core of the waveguide 202) may be matched or near-matched with the dielectric constant of seawater 102 in environment 100 of FIG. 1.

In some embodiments, the waveguide 202 may communicate RF signals and/or EM waves by using circular polarization. The probes 208, 210, 212, and/or 214 may be used to control the RF signals and/or EM waves coming into and/or out of the waveguide 202 to create a circular polarized waveguide 202. Note that probe 208 may be spatially positioned 90 degrees from probe 210, and probe 212 may be spatially positioned 90 degrees from probe 214, as is shown in FIG. 2. This spatial positioning of the probes may configure the waveguide 202 to utilize circular polarization when communicating one or more VHF and/or one or more UHF radio frequencies through, for example, seawater 102, sea ice 106, and/or air 104 of FIG. 1.

In some embodiments, circular polarization in antenna communications may offer one or more benefits, such as multipath mitigation, where the circular polarization helps reduce the effects of multipath interference(s), which occurs when signal reflections cause phase cancellation and/or signal degradation; orientation independence, where the RF signals can be received effectively even when the transmitter and receiver antennas may not be perfectly aligned and/or oriented; improved signal robustness, where the circularly polarized EM waves and/or RF signals can maintain their polarization after reflections, providing more consistent performance in compromised signal environments; polarization mismatch reduction, where the circular polarization minimizes mismatch losses that can occur when the transmitting and receiving antennas have different polarizations; antenna diversity, where the circular polarization can complement linear polarization in diversity schemes, improving the reliability and quality of communication links; a combination thereof; and/or other benefits. Generally, the use of circular polarization enhances performance in complex and/or harsh environments and improves the reliability of wireless communication systems.

Additionally, or alternatively, some satellites systems already use circular polarization when sending and/or receiving EM waves and/or RF signals. Therefore, the waveguide 202 may be utilized for underwater communication, or for communication from seawater 102 through sea ice 106 and through air 104 to communicate with the satellite 112 of FIG. 1.

In some embodiments, the antenna 110 of FIG. 1 and/or the waveguide 202 of FIG. 2 can communicate using one or more very high frequency (VHF) and/or one or more ultra high frequency (UHF) radio frequencies (RFs) through liquid water (e.g., the seawater 102 of FIG. 1). For example, an underwater vehicle (e.g., AUV 108 of FIG. 1) can communicate with another underwater vehicle (e.g., another AUV) using one or more VHF and/or one or more UHF radio frequencies through the seawater 102 of FIG. 1 and/or another type of liquid water, where each underwater vehicle can communicate with each other using or utilizing the waveguide 202 of FIG. 2.

The waveguide 202 of FIG. 2, however, can further be modified to be used in RF communication through one or more media, such as from seawater 102 through sea ice 106 and/or through air 104 of FIG. 1, where the respective dielectric constants of these media may differ from each other. To that end, the waveguide 202 of FIG. 2 can be modified, examples of which are illustrated and/or described herein.

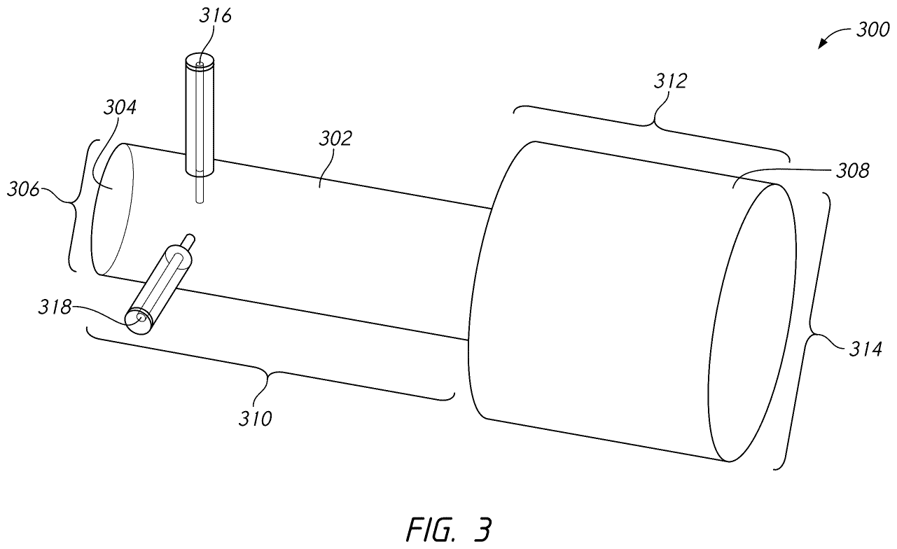

FIG. 3 shows a schematic of a waveguide 302 of an antenna 300, where the waveguide 302 includes a matching material 308 surrounding at least an open end of the waveguide 302, in accordance with examples described herein. FIG. 3 is illustrated and/or described in the context of FIG. 1 and/or FIG. 2. For example, the antenna 110 of FIG. 1 may be, may include, and/or may utilize the waveguide 202 of FIG. 2, the waveguide 302 of FIG. 3, and/or the antenna 300 of FIG. 3.

In some embodiments, the antenna 300 may include a waveguide 302, an end 304 of the waveguide 302, another end of the waveguide 302 (not shown in FIG. 3), a diameter 306 of the waveguide 302, a matching material 308, a first length 310 of the waveguide 302, a length 312 of the matching material 308, a diameter 314 of the matching material 308, a probe 316, and/or a probe 318.

In some embodiments, the end 304 of the waveguide 302 may be a first closed end, and the other end (not shown in FIG. 3) of the waveguide 302 may be a second open end, where the matching material 308 surrounds at least the second open end of the waveguide 302.

In some embodiments, the waveguide 302 and/or the antenna 300 may be used to transmit and/or deliver RF signals into silicone oil. Generally, silicone oil may be utilized in antenna designs for its dielectric properties, thermal stability, wide-spread manufacturing availability, cost, and/or other reasons. Silicon oil can help manage the EM waves and/or RF signals and/or improve impedance matching. Additionally, or alternatively, silicone oil may provide effective thermal management by dissipating heat, which is crucial in maintaining performance stability in high-power applications and/or environments with extreme temperatures. Additionally, or alternatively, silicon oil may offer moisture protection. Additionally, or alternatively, silicon oil may enhance the longevity and/or reliability of the antenna components by preventing corrosion and/or oxidation. Additionally, or alternatively, silicon oil is generally stable and/or safe to be used in the environment 100 of FIG. 1.

In some embodiments, silicon oil may have a dielectric constant (or a relative permittivity), εᵣ, of approximately 2.7 at an operating or center frequency of, for example, 400 MHz. In such a scenario, the matching material 308 between the waveguide 302 and the silicone oil can lower or minimize the reflection at the connecting surface. Note that the satellites of Argos utilize a communication frequency and/or the operating frequency of approximately 400 MHz. If the satellite 112 of FIG. 1 is part of Argos, then the AUV 108 may configure the antenna 110 of FIG. 1 and/or the antenna 300 of FIG. 3 to communicate with an operating or center frequency of 400 MHZ. Therefore, the antenna 300 may communicate EM waves and/or RF signals through one or more media, such as from the seawater 102 through the sea ice 106 and/or through the air 104 of FIG. 1, where these media may have different dielectric constants, εᵣ, from each other.

In some embodiments, the matching material 308 may be or include barium tetratitanate (BaO9Ti4), which may have a dielectric constant (or a relative permittivity), εᵣ, of approximately 37, depending on the operating frequency of the antenna 300 of FIG. 3.

In some embodiments, the antenna 300 of FIG. 3 may be designed by utilizing a high-frequency structure simulator (HFSS) (e.g., Ansys HFSS). An example design of the antenna 300 of FIG. 3 may include a diameter 306 of the waveguide 302 of approximately 48 mm; a diameter 314 of the matching material 308 of approximately 100 mm; a length 310 of the waveguide 302 of approximately 150 mm; a length 312 of the matching material 308 of approximately 90 mm; a dielectric constant (or a relative permittivity), εᵣ, of the waveguide 302 of approximately 96; and a dielectric constant (or a relative permittivity), εᵣ, of the matching material 308 of approximately 37.

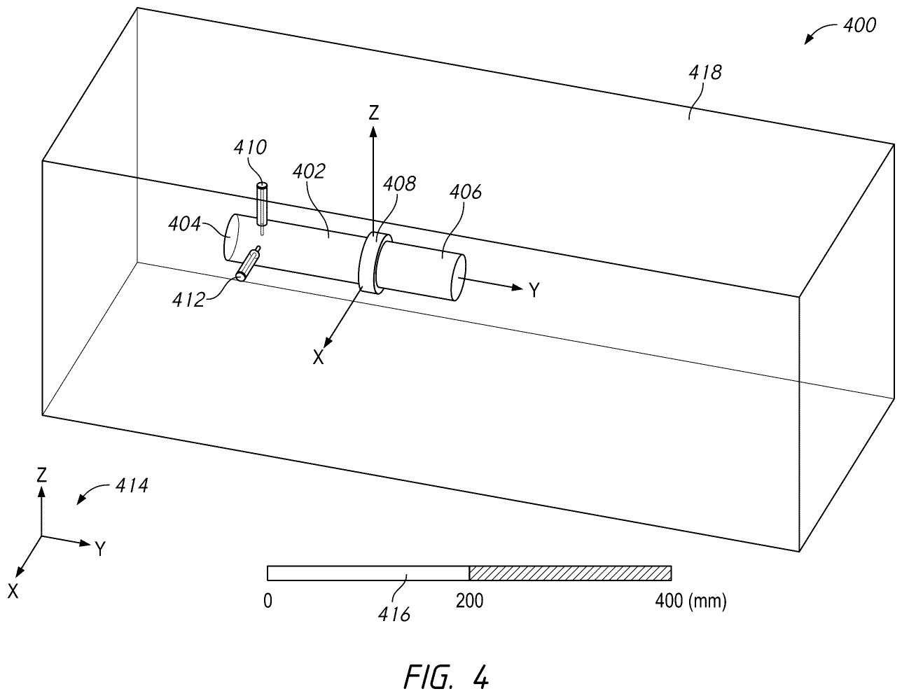

FIG. 4 shows an antenna 400 with a waveguide 402, a matching material 406 surrounding at least an open end of the waveguide 402, and a ring 408 in the intercept of the waveguide 402 and the matching material 406, in accordance with examples described herein.

In some embodiments, the antenna 400 may include a waveguide 402, an end 404 of the waveguide 402, another end of the waveguide 402 (not illustrated), a matching material 406, a ring 408, a probe 410, a probe 412, a 3D axes 414, a scale 416, and a simulator box 418. FIG. 4 is illustrated and/or described in the context of FIG. 1, FIG. 2, and/or FIG. 3. For example, the antenna 110 of FIG. 1 may be, may include, and/or may utilize the waveguide 202 of FIG. 2, the waveguide 302 of FIG. 3, the antenna 300 of FIG. 3, and/or the antenna 400 of FIG. 4. As another example, the waveguide 402 of FIG. 4 may be the same as or equivalent to the waveguide 302 of FIG. 3. As yet another example the probe 410 and the probe 412 of FIG. 4 may be the same as or equivalent to the probe 316 and the probe 318 of FIG. 3, respectively.

In some embodiments, the antenna 400 may be designed and/or optimized using a simulator by, for example, using the simulator box 418 around the antenna 400, such as by using the Ansys HFSS.

In some embodiments, the end 404 of the waveguide 402 may be a first closed end, and the other end (not shown in FIG. 4) of the waveguide 402 may be a second open end, where the matching material 406 surrounds at least the second open end of the waveguide 402.

In some embodiments, a matching material 406 with a smaller diameter may be desired to be fitted at an AUV (e.g., the AUV 108 of FIG. 1), since the space in or on the AUV may be limited. For example, the diameter of the matching material 406 of FIG. 4 may be smaller than the diameter of the matching material 308 of FIG. 3. In such a case, the smaller diameter of the matching material 406 may cause a considerable RF signal diffraction at the interface of the waveguide 402 and the matching material 406 of FIG. 4. In some embodiments, the RF signal diffraction may occur at the interface between the waveguide 402 and the matching material 406, preventing the waveguide 402 to deliver power into the silicone oil (not shown in FIG. 4). To reduce or minimize the RF signal diffraction, the antenna 400 may include the ring 408 between the waveguide 402 and the matching material 406. The ring 408 may be or include a high loss dielectric material to attenuate the diffracted EM wave and/or the RF signal to cancel one or more standing waves formed between the diffracted waves and transmitted waves.

In some embodiments, the ring 408 may be filled with seawater, glycol, titania, and/or another material with the same or similar dielectric constant (or a relative permittivity), εᵣ. The ring 408 between the interface of the waveguide 402 and the matching material 406 helps the energy of the EM waves and/or RF signals to avoid or minimize radiation into silicon oil (not shown in FIG. 4). In some embodiments, most or all of the energy of the EM waves and/or the RF signals may be diffracted and/or absorbed by the ring 408. Consequently, little energy may be reflected back to the waveguide 402 (and/or the end 404 of the waveguide 402) and/or radiated into the silicon oil.

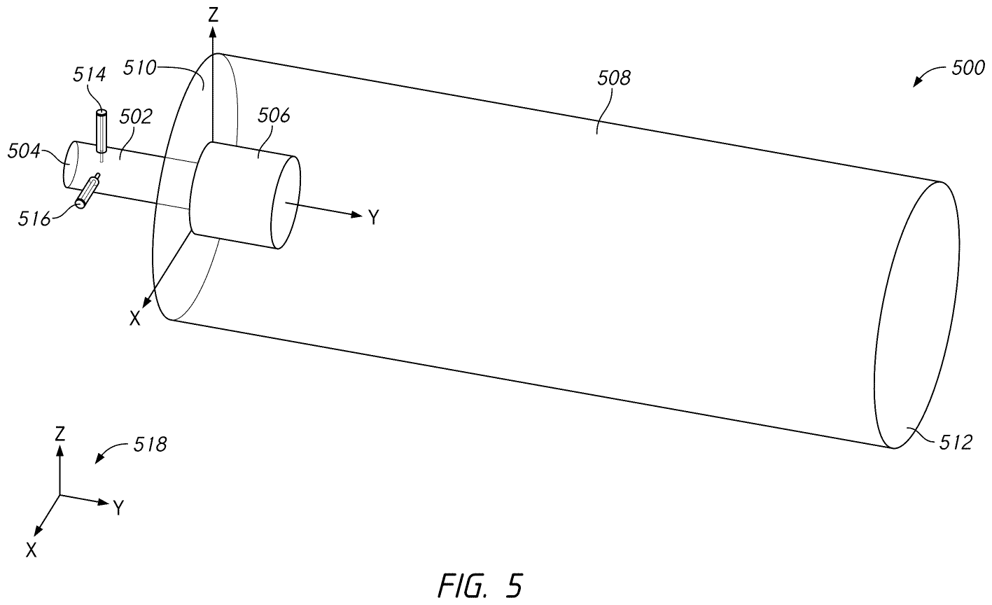

FIG. 5 shows an antenna 500 with a waveguide 502, a matching material 506 surrounding at least an open end of the waveguide 502, and a guide tube 508 surrounding at least a portion of the matching material 506, in accordance with examples described herein.

In some embodiments, the antenna 500 may include a waveguide 502, an end 504 (e.g., a closed end) of the waveguide 502, another end (e.g., an open end, not shown) of the waveguide 502, a matching material 506 surrounding the open end of the waveguide 502, a guide tube 508, an end 510 of the guide tube 508, an end 512 of the guide tube 508, a probe 514, a probe 516, and a 3D axes 518. The antenna 500 is illustrated and/or described in the context of antenna 110 of FIG. 1, the environment 100 of FIG. 1, the antenna 200 of FIG. 2, the antenna 300 of FIG. 3, and/or the antenna 400 of FIG. 4.

In some embodiments, the probe 514 and the probe 516 may be utilized to control the RF signals and/or EM waves coming into the waveguide 502 to create a circular polarized waveguide 502 and/or antenna 500. Note that probe 514 may be spatially positioned 90 degrees from probe 516, as is shown in FIG. 5. This spatial positioning of the probes can be used to configure the waveguide 502 and/or the antenna 500 to utilize circular polarization when communicating one or more VHF and/or one or more UHF radio frequencies through, for example, seawater 102, sea ice 106, and/or air 104 of FIG. 1.

In some embodiments, however, when the antenna contacts the bottom of the sea ice 106 of FIG. 1 in the environment 100, there is a possibility that the antenna and/or the AUV 108 could be damaged. If the antenna and/or the AUV 108 is damaged, there may be an exposure of the RF signal into seawater 102, which may result in a significant RF signal loss. To avoid and/or mitigate such damages, the antenna 500 may include the guide tube 508. The guide tube 508 can then be utilized to guide the RF signal from the waveguide 502 (e.g., a loaded waveguide 502) to the bottom of the sea ice 106 of FIG. 1.

In some embodiments, the guide tube 508 may be flexible and/or relatively small. As is illustrated in FIG. 5, the radius of the guide tube 508 is larger than the radius of the guide tube 508 and/or the radius of the waveguide 502. Therefore, the flexibility of the guide tube 508 may still accommodate a rigid or semi-rigid waveguide 502 and/or the matching material 506. In some embodiments, the guide tube 508 may be filled with silicon oil and coated with a metal material, such as aluminum, titanium, or another metal material that is not prone to corrosion.

An example radius of the guide tube 508 may be approximately 143 mm. An example length of the guide tube 508 may be approximately 800 mm. Leveraging Equation 1, the radius of the guide tube 508 may be calculated by multiplying the radius of the waveguide 502 by the ratio between the dielectric constant (or a relative permittivity), εᵣ, of the core (or dielectric material) of the waveguide 502 with the dielectric constant (or a relative permittivity), εᵣ, of the core (or dielectric material) of the guide tube 508. For example, the dielectric material of the waveguide 502 may be titania (TiO₂), and the guide tube 508 may be filled with silicon oil. As another example, the dielectric material of the waveguide 502 may be water, seawater, glycol, or a combination thereof, and the guide tube 508 may be filled with silicon oil.

The length of the guide tube 508 may not be arbitrary in some examples. Generally, a shorter than necessary or optimal or a longer than necessary or optimal guide tube 508 may cause an increase of the reflection coefficient. For example, when the length of the guiding tube is extended to 1300 mm (e.g., from 800 mm to 1300 mm), the S11 may be increased to approximately −3.76 decibels (dB). As another example, when the length of the guide tube is shrunk to 300 mm (e.g., from 800 mm to 300 mm), the S11 may be increased to approximately-4.62 dB.

Additionally, or alternatively, other factors may affect the performance of the waveguide 502 connected to the guide tube 508 of the antenna 500, such as the relative location between the waveguide 502 and the guide tube 508; the radius of the waveguide 502; the radius of the matching material 506; the radius of the guide tube 508; the materials of the waveguide 502, the matching material 506, and/or the guide tube 508; a combination thereof; and/or other factors.

In some embodiments, if the guide tube 508 is filled with silicone oil, a shorter guide tube 508 may be preferable when there is a space limitation regarding or around the AUV 108 of FIG. 1. One approach to improve the power delivery from the waveguide 502 to the end 512 of the guide tube 508 may be to use a flared-shape guide tube, such that the radius of the end 512 of the guide tube 508 is larger than the end 512 of the guide tube 508 (not illustrated as such in FIG. 5). The dimension of the flaring of the guide tube 508 may be determined using Equation 2.

In some embodiments, in Equation 2, b may represent the diameter of the waveguide 502 (e.g., the diameter of end 504 of the waveguide 502), B may represent the opening or the flaring (e.g., the diameter of the end 512) of the guide tube 508, λ may represent the wavelength of the EM wave and/or RF signal, and R_{E} may represent the length of the flared portion of the guide tube 508 in, for example, the y-axis of FIG. 5.

$$B = \frac{1}{2} ( b + \sqrt{{b}^{2} + 8 λ {R}_{E}} ) \qquad ( Equation 2 )$$

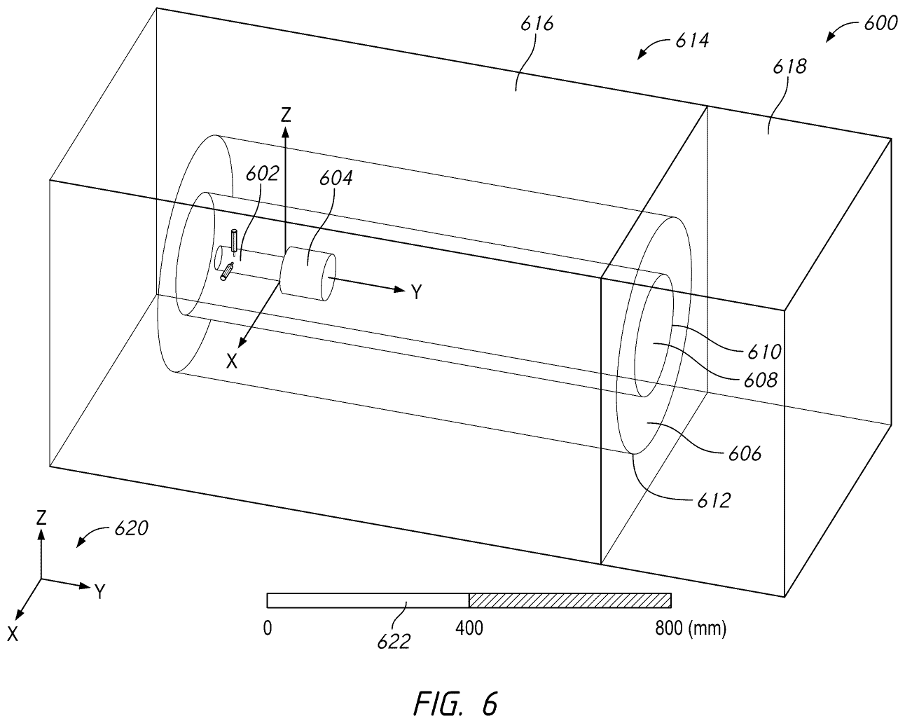

FIG. 6 shows an antenna 600 with a waveguide 602, a matching material 604 surrounding at least an open end of the waveguide 602, and a guide tube surrounding at least a portion of the matching material 604, where the guide tube includes an inner layer 608 and an outer layer 606, in accordance with examples described herein.

In some embodiments, the antenna 600 may include a waveguide 602, a matching material 604 surrounding an open end of the waveguide 602, an outer layer 606 of a guide tube, an inner layer 608 of the guide tube, a metal material 610, a metal material 612, a simulator box 614 (e.g., Ansys HFSS) to simulate the design of the antenna 600, a seawater 616 portion of the simulator box 614, a sea ice 618 portion of the simulator box 614, a 3D axes 620, and a scale 622.

FIG. 6 is illustrated and/or described in the context of FIG. 1, FIG. 2, FIG. 3, FIG. 4, and/or FIG. 5. A difference between the antenna 500 of FIG. 5 and the antenna 600 of FIG. 6 is that the guide tube of the antenna 600 includes two layers (e.g., instead of one layer of the guide tube 508 in FIG. 5). Specifically, the guide tube of the antenna 600 includes the outer layer 606 and the inner layer 608. In some embodiments, the outer layer 606 may be surrounded by the metal material 612, and the inner layer 608 may be surrounded by the metal material 610. The metal material 610 of the guide tube of the antenna 600 may be or create an inner tube, and the metal material 612 of the guide tube of the antenna 600 may be or create an outer tube.

In some embodiments, using two layers in the guide tube of the antenna 600 of FIG. 6 may be useful to guide the EM waves and/or RF signals from the waveguide 602 to the sea ice (e.g., represented as the sea ice 618 portion of the simulator box 614).

In some embodiments, the dielectric constant (or a relative permittivity), εᵣ, of the dielectric material of the inner layer 608 (or the core of the inner tube) may be higher than a dielectric constant (or a relative permittivity), εᵣ, of the dielectric material of the outer layer 606 (e.g., the dielectric material between the outer tube and the inner tube). For example, the metal material 610 may be filled with silicon oil, and the metal material 612 may be filled with air.

In some embodiments, if the sizes of the two layers are optimized or well-designed, the EM waves and/or the RF signals can be trapped within the inner tube due to a total or a near-total reflection. Some evanescent EM waves may still be presented in the outer tube. Nevertheless, most of the energy may be trapped inside the inner tube.

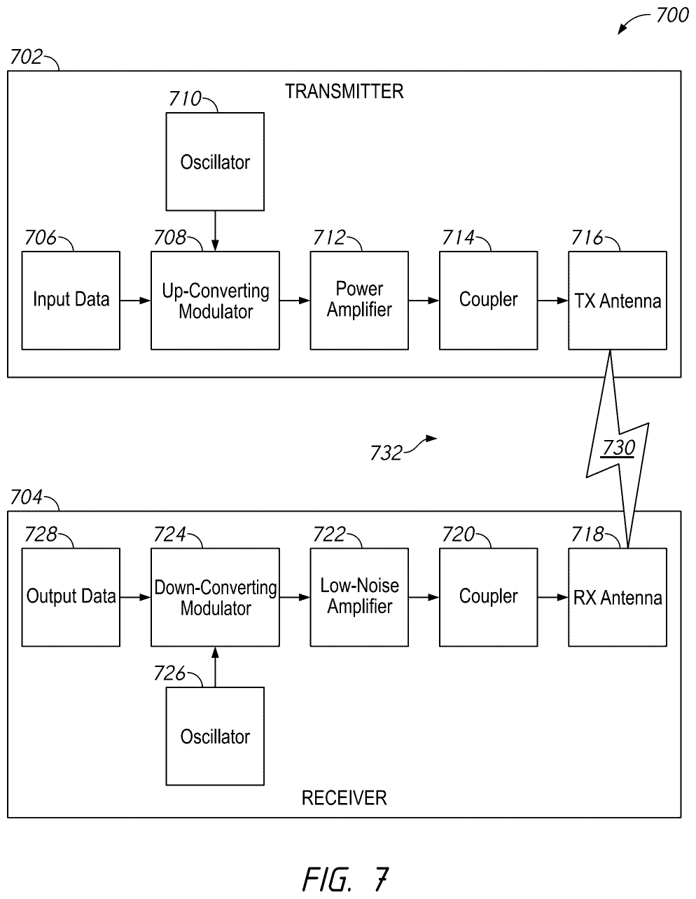

FIG. 7 shows a system 700 with a transmitter 702 and a receiver 704, where the transmitter 702 is communicatively coupled (e.g., communicates wirelessly) with the receiver 704, in accordance with examples described herein. The system 700 is illustrated and/or described in the context of FIG. 1, FIG. 2, FIG. 3, FIG. 4, FIG. 5, and/or FIG. 6. For example, the transmitter 702 of FIG. 7 may be utilized by the AUV 108 of FIG. 1. As another example, the receiver 704 of FIG. 7 may be utilized by the satellite 112 of FIG. 1. As yet another example, the receiver 704 of FIG. 7 may be utilized by another AUV (not illustrated), and the transmitter 702 of the AUV 108 may be communicatively coupled with the receiver 704 of the other AUV. The transmitter 702 and/or the receiver 704 may utilize antennas described herein.

In some embodiments, the transmitter 702 may include input data 706, an up-converting modulator 708, an oscillator 710, a power amplifier 712, a coupler 714, a TX antenna 716 (e.g., a transmitter antenna), other electronic components, additional electronic components, and/or fewer electronic components.

In some embodiments, the TX antenna 716 of FIG. 7 may be the same or equivalent with the antenna 110 of FIG. 1, the antenna 200 of FIG. 2, the antenna 300 of FIG. 3, the antenna 400 of FIG. 4, or the antenna 500 of FIG. 5.

In some embodiments, the receiver 704 may include an RX antenna 718 (e.g., a receiver antenna), a coupler 720, a low-noise amplifier 722, a down-converting modulator 724, an oscillator 726, output data 728, other electronic components, additional electronic components, and/or fewer electronic components.

In some embodiments, the transmitter 702 and the receiver 704 may be communicatively coupled, where the TX antenna 716 of the transmitter 702 is communicatively coupled with the RX antenna 718 of the receiver 704 using a wireless communication 730.

In some embodiments, the RX antenna 718 of FIG. 7 may be the same as or equivalent to the antenna 110 of FIG. 1, the antenna 200 of FIG. 2, the antenna 300 of FIG. 3, the antenna 400 of FIG. 4, or the antenna 500 of FIG. 5.

In some embodiments, the wireless communication 730 of FIG. 7 may be the same as or equivalent to the wireless communication 114 of FIG. 1.

In some embodiments, the transmitter 702 communicates with the receiver 704 through one or more propagation media 732, such as through seawater 102, sea ice 106, and/or air 104 of FIG. 1.

In some embodiments, the frequency of the oscillator 710 may be configured to operate at the operating frequency of the transmitter 702, any of the antenna described herein, and/or the system 700. Similarly, the frequency of the oscillator 726 may be configured to operate at the operating frequency of the receiver 704, any of the antennas described herein, and/or the system 700. In some embodiments, the frequencies of the oscillator 710 and/or the oscillator 726 may be a specific radio frequency of one or more VHF and/or one or more UHF radio frequencies. For example, assume the transmitter 702 is located in or on the AUV 108 of FIG. 1, and assume that the receiver 704 is located in or on the satellite 112. In such a case, the oscillating frequencies of the oscillator 710 and/or the oscillator 726 may be the operating frequencies of the satellite 112 or the constellation of satellites that includes the satellite 112 of FIG. 1.

In some embodiments, the up-converting modulator 708 of the transmitter 702 can be used to shifts the frequency of a baseband or an intermediate frequency (IF) signal to a higher frequency for transmission. This process is used to transmit RF signals over desired communication channels. As is illustrated in FIG. 7, the up-converting modulator 708 is coupled to the oscillator 710 of the transmitter 702. The up-converting modulator 708 can use the oscillator 710's signal to accomplish frequency translation. The oscillator 710 can generate a stable, high-frequency signal, which is sometimes referred to as a carrier wave.

In some embodiments, the transmitter 702 can achieve or include a mixer, by combining the input signal with the carrier frequency from the oscillator 710, and the mixer outputs the sum and difference of these frequencies; a local oscillator (LO), providing a precise carrier frequency necessary for modulation; a filter (not illustrated in FIG. 7), such as a bandpass filter that selects the desired frequency range while rejecting unwanted frequencies; the power amplifier 712 to increase the power level of the RF signal before transmission; the coupler 714; and the TX antenna 716.

In some embodiments, the down-converting modulator 724 of the receiver 704 may sometimes be referred to as a mixer. The down-converting modulator 724 can be configured to shift the frequency of an incoming signal to a lower intermediate frequency (IF) for easier processing. In this process, the received radio frequency (RF) signal can be mixed with a local oscillator (LO) (e.g., the oscillator 726) signal to produce the IF signal. The down-converting modulator 724 is coupled to the local oscillator (LO) or the oscillator 726. The local oscillator's frequency (e.g., the frequency of the oscillator 726) is chosen to achieve the desired IF, and the coupling ensures that the mixer (e.g., the down-converting modulator 724) receives stable and precise oscillation. This modulation process may be used for subsequent demodulation and/or signal processing stages within the receiver, enabling efficient extraction of the desired signals from the RF spectrum.

In some embodiments, the coupler 714 and/or the coupler 720 may be a 90-degree hybrid coupler. Generally, a 90-degree hybrid coupler is a four-port passive device used in RF and/or microwave applications for signal dividing and combining. The 90-degree hybrid coupler is generally designed to split an input signal equally into two output signals with a 90-degree phase difference, or to combine two signals with the same phase relationship.

In some embodiments, in the context of the transmitter 702 and/or the receiver 704, the 90-degree hybrid couplers may provide signal isolation, where the 90-degree hybrid coupler maintains high isolation between ports, thereby reducing signal interference from the transmitter 702 and the receiver 704; power division; phase shifting; impedance matching; and/or other benefits.

In some embodiments, the TX antenna 716 and/or the RX antenna 718 may be circularly polarized antennas with loaded waveguides.

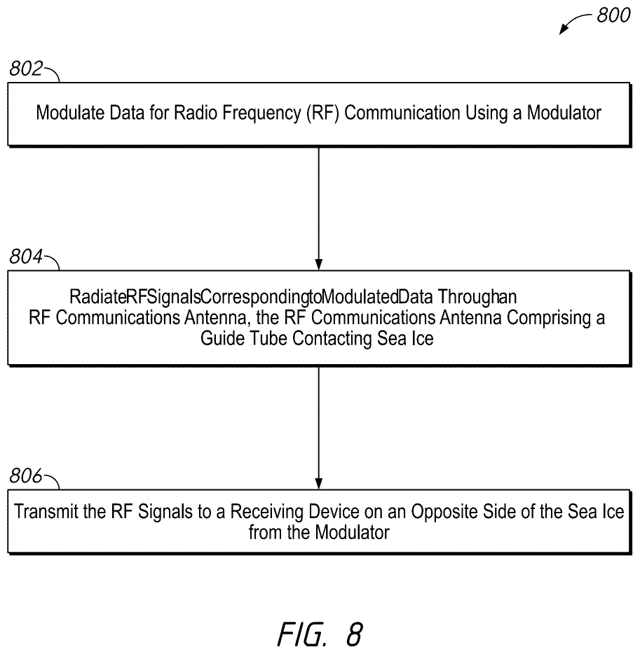

FIG. 8 shows a block diagram of a method 800 to transmit radio frequencies using a guide tube, where the guide tube contacts sea ice, in accordance with examples described herein. FIG. 8 is illustrated and/or described in the context of FIG. 1, FIG. 2, FIG. 3, FIG. 4, FIG. 5, FIG. 6, and/or FIG. 7.

In block 802, the method 800 modulates data (e.g., modulated the input data 706 of FIG. 7) for RF communication using a modulator. In some embodiments, the modulator can be the up-converting modulator 708 of the transmitter 702 of FIG. 7.

In block 804, the method 800 radiates RF signals corresponding to the modulated data through an RF communications antenna. The RF communications antenna can be or include the antenna 110 of FIG. 1, the antenna 500 of FIG. 5, the antenna 600 of FIG. 6, and/or the TX antenna 716 of FIG. 7. The RF communications antenna includes a guide tube contacting sea ice. For example, the RF communication antenna may be emersed mainly in seawater 102 of FIG. 1, and a portion of the RF communications antenna contacts the bottom of sea ice 106 of FIG. 1. Specifically, the guide tube of the RF antenna contacts the bottom of the sea ice 106.

In block 806, the method 800 transmits the RF signals to a receiving device (e.g., receiver 704 of FIG. 7) on an opposite side of the sea ice from the modulator. For example, the receiver may be part of the satellite 112 of FIG. 1.

In some embodiments, RF communication may include a relatively wide bandwidth, such as approximately 6%, 8%, 10%, 12%, 14%, 16%, 18%, 20%, 22% etc. with respect to the center and/or operating frequency of the RF communication.

FIG. 9A and FIG. 9B show the first-year and multi-year, respectively, of sea ice (e.g., the sea ice 106 of FIG. 1) attenuation as a function of frequency. Specifically, the graphs of FIG. 9A and FIG. 9B show the penetration depth in meters (m) versus the RF frequency in gigahertz (GHz), where the RF frequency is plotted using a logarithmic scale. This data can be used when designing the antenna 110 of FIG. 1, the waveguide 202 of FIG. 2, the antenna 300 of FIG. 3, the antenna 400 of FIG. 4, the antenna 500 of FIG. 5, the antenna 600 of FIG. 6, and/or the system 700 of FIG. 7.

From the foregoing it will be appreciated that, although specific embodiments have been described herein for purposes of illustration, various modifications may be made while remaining within the scope of the claimed technology. Examples described herein may refer to various components as “coupled” or signals as being “provided to” or “received from” certain components or nodes. It is to be understood that in some examples, the components are directly coupled one to another, while in other examples, the components are coupled with intervening components disposed between them.

Similarly, signals or communications may be provided directly to and/or received directly from the recited components without intervening components, but also may be provided to and/or received from the certain components through intervening components.

What is claimed is:

1. An antenna comprising a waveguide with a dielectric material disposed within the waveguide, wherein:
the dielectric material comprises a dielectric constant matched or near-matched to a dielectric constant of liquid solution; and
the antenna is selectively configured to communicate using one or more very high frequency (VHF) radio frequencies through liquid solution.

2. The antenna of claim 1 is further selectively configured to communicate using one or more VHF or one or more ultra high frequency (UHF) radio frequencies through liquid solution.

3. The antenna of claim 2, wherein the waveguide and the dielectric material collectively comprise a loaded waveguide, the loaded waveguide being smaller in size compared to an otherwise unloaded waveguide configured to communicate the one or more VHF, the one or more UHF, or combinations thereof radio frequencies.

4. The antenna of claim 2, wherein the waveguide comprises a first closed end and a second open end, and wherein the antenna further comprises:
a matching material surrounding at least the second open end of the waveguide, wherein the matching material comprises a dielectric constant based on a dielectric constant of ice or frozen water; and
a guide tube surrounding at least a portion of the matching material; wherein:
the waveguide and the matching material are disposed in the guide tube; and
the guide tube is configured to contact the ice or the frozen water through which the antenna will broadcast.

5. The antenna of claim 1, wherein the antenna is configured for underwater communication between a first underwater vehicle and a second underwater vehicle.

6. The antenna of claim 4 is further selectively configured to operate about a center frequency of approximately 400 MHz for transmitting radio frequencies from liquid water through the ice or the frozen water, wherein the antenna is located underwater in the liquid water.

7. The antenna of claim 4, wherein:
the liquid solution, the liquid water, or combinations thereof comprises seawater; and
the ice or the frozen water comprises sea ice.

8. The antenna of claim 4, wherein the matching material comprises barium tetratitanate (BaO9Ti4).

9. The antenna of claim 4, wherein the guide tube comprises silicon oil surrounded by a metal material.

10. The antenna of claim 4, wherein the guide tube further comprises an inner layer and an outer layer, the inner layer comprising a higher relative dielectric material than the outer layer.

11. The antenna of claim 10, wherein a metal layer surrounds the inner layer, and wherein the outer layer is surrounded by another metal material.

12. The antenna of claim 10, wherein the higher relative dielectric material comprises silicon oil, and a lower relative dielectric material comprises air.

13. A method comprising:
modulating data for radio frequency (RF) communication using a modulator;
radiating RF signals corresponding to modulated data through an RF communications antenna, the RF communications antenna comprising a guide tube contacting sea ice; and
transmitting the RF signals to a receiving device on an opposite side of the sea ice from the modulator.

14. The method of claim 13, wherein the transmission further compromises transmitting the signals using circularly polarized RF waves.

15. The method of claim 13, wherein the RF signals comprise a bandwidth of approximately 20% with respect to an operating RF.

16. The method of claim 13, wherein the receiving device comprises one or more satellites.

17. A system for communicating radio frequency (RF) signals, the system comprising:
a transmitter configured to transmit data using one or more very high frequency (VHF) or one or more ultra high frequency (UHF) radio frequencies through seawater, wherein the transmitter comprises an antenna having a waveguide with a dielectric material disposed within the waveguide, the dielectric material having a dielectric constant based on a dielectric constant of seawater; and
a receiver configured to receive the one or more VHF or the one or more UHF radio frequencies representative of the data, wherein the receiver is located in seawater, in or on sea ice, or on air.

18. The system of claim 17, wherein the transmitter further comprises:
an oscillator; and
a modulator coupled to the oscillator and the antenna, wherein the modulator modulates the data.

19. The system of claim 18, wherein the dielectric material of the waveguide is matched or near-matched to the dielectric constant of seawater, and wherein the dielectric material comprises seawater, glycol, titania (TiO₂), or combinations thereof.

20. The system of claim 18, wherein the receiver comprises another antenna, and wherein the antenna of the transmitter is communicatively coupled to the antenna of the receiver to communicate the data wirelessly between the transmitter and the receiver.
